(19) United States
(12) Patent Application Publication
(10) Pub. No.: US 2006/0265437 A1
(43) Pub. Date: Nov. 23, 2006

(54) Contiguous boot and resume start-up files

(76) Inventor: Richard L. Coulson, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/135,729

(22) Filed: May 23, 2005

(51) Int. Cl. G06F 17/30

(52) U.S. Cl. 707/205

(57) ABSTRACT

Various embodiments of the invention may write start-up files to contiguous locations in a storage medium before entering a powerdown state. After entering the powerdown state, to start a new operational state the start-up files may be read from the contiguous locations rather than from conventional non-contiguous locations, thus reducing the amount of time required to access those start-up files and reach the operational state.

### BACKGROUND

Booting up a modern computer system can take quite a bit of time, due to the volume of files that have to be retrieved and the time it takes to retrieve those files. Much of the time spent retrieving files from disk is due to random disk accesses. Due to the nature of frequently replacing files in available spaces on the disk, after a while the files tend to become fragmented, and scattered across various tracks and sectors of the disk. Seeking a new track on the disk may take up to several milliseconds, and once on track, waiting for the correct sector to pass under the read head may also consume a lot of time. The result is that much of the time it takes to boot a system (or alternately, to resume from a hibernation state) may be spent waiting for the data from the disk to become available.

### BRIEF DESCRIPTION OF THE DRAWINGS

Some embodiments of the invention may be understood by referring to the following description and accompanying drawings that are used to illustrate embodiments of the invention. In the drawings:

FIGS. 1A, 1B show a flow diagram of a method, according to an embodiment of the invention.

FIG. 2 shows a flow diagram of a method of accessing start-up files for use, according to an embodiment of the invention.

FIG. 3 shows a diagram of a computer system, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements co-operate or interact with each other, but they may or may not be in direct physical or electrical contact.

The term “processor” may refer to any device or portion of a device that processes electronic data from registers and/or memory to transform that electronic data into other electronic data that may be stored in registers and/or memory. A “computing platform” may comprise one or more processors.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Various embodiments of the invention may be implemented in one or a combination of hardware, firmware, and software. The invention may also be implemented as instructions contained on a machine-readable medium, which may be read and executed by a computing platform to perform the operations described herein. A machine-readable medium may include any mechanism for storing, transmitting, or receiving information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), the interfaces and/or antennas that transmit and/or receive those signals; and others.

Various embodiments of the invention may write start-up files to substantially contiguous locations in a non-volatile storage medium such as a disk before entering a powerdown state. After entering the powerdown state, to start a new operational state, the start-up files may be read from the contiguous locations rather than from the conventional non-contiguous locations, thus reducing the amount of time spent in seeking new tracks and sectors, two operations which could otherwise contribute a significant amount of the time required to start the system. In some embodiments, similar but different sets if start-up files may be used for boot and for resume operations. As used herein, ‘start-up files’ may comprise various types of files needed to bring a system to a state of operational readiness, such as but not limited to: 1) boot files, 2) resume files, 3) plug in files, 4) application files that are to be automatically activated upon start-up, 5) applications files and/or data files often used/opened in the first few minutes of operation, 6) etc. Within the context of this document, ‘non-contiguous locations’ may indicate the locations of start-up files of a conventional system in which there is no attempt to keep all the start-up files in contiguous locations (although they might initially be placed that way). ‘Contiguous locations’ may indicate start-up files that are intentionally placed into substantially contiguous locations so that they may later be read from those substantially contiguous locations. A disk may contain both start-up files in non-contiguous locations, and start-up files in contiguous locations that are copies of the start-up files in the non-contiguous locations, but that have been arranged to occupy substantially contiguous locations.

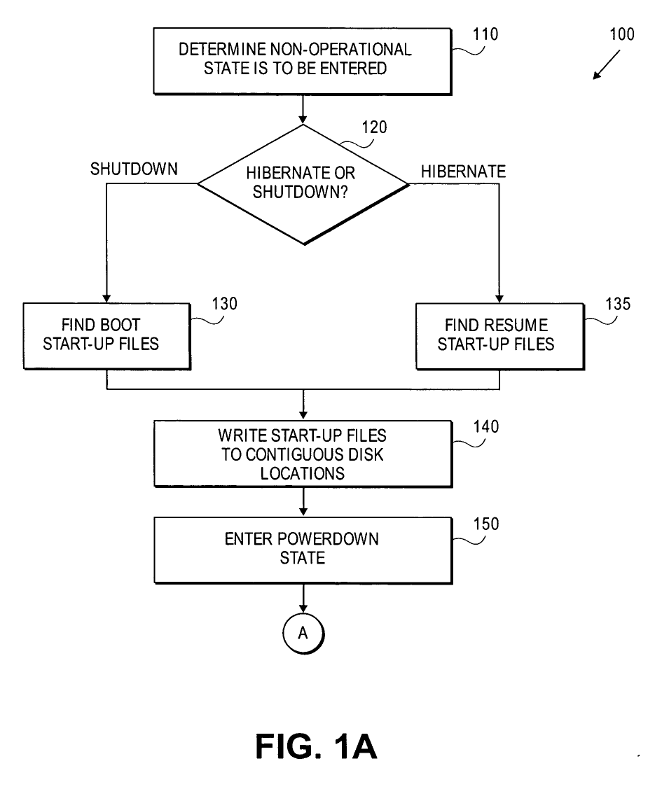

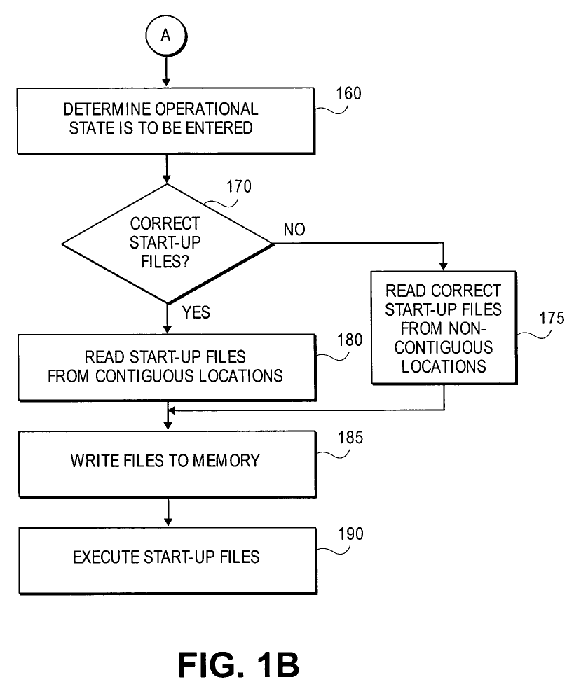

FIGS. 1A, 1B show a flow diagram of a method, according to an embodiment of the invention. In flow diagram 100, at 110 it may be determined that the processor(s) of a computer system are to enter a powerdown state. Such a determination may be made in various ways, such as but not limited to: 1) sensing the pressing of a power button, 2) reaching the limit of a time-out period, 3) closing the lid of a portable device, 4) receiving a command to enter the powerdown state, 5) etc. Various embodiments may also have other elements of the computer system enter a powerdown state. In some embodiments the powerdown state may result in a full or partial loss of the contents of the memory from where the processor(s) obtain instructions and/or data, so that the contents may have to be restored from a disk drive when an operational state is entered again.

At 120 it may be determined what type of powerdown state is to be entered, e.g., shutdown or hibernate. Although both states may involve the removal of power from the processing and memory components, within the context of this document the two terms imply the following: 1) a shutdown state implies that the system state is not saved, so that a full boot must be performed at start-up. 2) A hibernate state implies that some of the system state, possibly including the contents of memory, may be preserved in non-volatile storage, so that the system state of the processor and memory may be restored directly from these saved files. Although the terms ‘shutdown’ and ‘hibernate’ are used as examples here, various embodiments of the invention may not be limited to states that are described with those terms, and some embodiments may accommodate more than two such powerdown states.

If a shutdown state is to be entered, as determined at 120, the start-up files for a system boot (i.e., the files needed to restart from a shutdown state) may be located at 130, while if a hibernate state is to be entered, at 135 the start-up files for a resume operation (i.e., the files needed to restart from a hibernate state) may be located. As stated previously, there may also be other types of powerdown states that require a different set of start-up files to restart the computer system. Regardless of which set of start-up files are located, at 140 those files may be written to substantially contiguous locations on the disk so that they may later be read from the disk sequentially, without an excessive amount of track seeks and sector waits that are common in conventional operations that have the start-up files scattered around in non-contiguous locations on the disk. In some embodiments, ‘contiguous’ may indicate sequentially addressable sectors within a track. In some embodiments, ‘contiguous’ may also indicate that once the end of a single track on the disk platter is reached, the next location to be read is on an adjacent track. In some embodiments, ‘contiguous’ may indicate that once the end of a single track on a single surface of a disk platter is reached, the next location to be read is on the same track of another surface of the same or different platter.

The term ‘substantially contiguous’ is used herein to acknowledge that fact that various disk drives may have characteristics that make the use of strictly contiguous locations infeasible, or that would defeat the time-saving purpose of using contiguous locations. However, such slight deviations from using strictly contiguous locations is considered to be within the scope of the claimed embodiments. The terms ‘contiguous’ and ‘substantially contiguous’, as used herein, should both be considered to mean ‘substantially contiguous’ unless specifically described otherwise (such as by the term ‘strictly contiguous’).

Besides writing the start-up files to disk, other operations (not described) may also be performed to prepare the system for a powerdown state. Once all needed operations have been performed, the system may enter the powerdown state at 150.

Continuing in FIG. 1B, it may be determined at 160 that an operational state is to be entered. This determination may be made in various ways, such as but not limited to: 1) sensing the pressing of a power button, 2) sensing the opening of the lid of a portable device, 3) sensing the pressing of a key on a keyboard, 4) etc. In some embodiments a check may be made at 170 to determine if the start-up files located in the contiguous locations are the correct start-up files for the type of start-up that is to be performed (e.g., if a cold boot is to be performed, but the files are for a resume from hibernate, then the files might be incorrect). If the start-up files located in contiguous locations are incorrect, then the start-up files located in non-contiguous locations (e.g., the files that would be retrieved in a conventional start-up) may be retrieved at 175. If the files are correct, then the correct files may be read from the contiguous locations at 180. In some embodiments, the operation of reading these files from the contiguous location on the disk may be performed without being initiated by the operating system, which may or may not be aware of the existence of the start-up files located in contiguous locations (e.g., because the operating system is not operational yet, or because these locations are not visible to the operating system). Whichever files have been read from disk may be written to memory at 185, from where they may be handled in various ways, such as by being executed at 190.

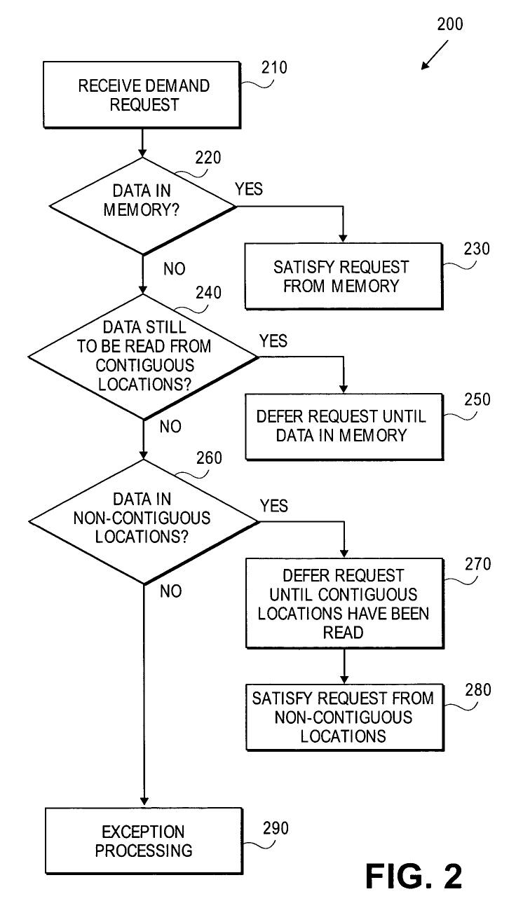

FIG. 2 shows a flow diagram of a method of accessing start-up files for use, according to an embodiment of the invention. Although the start-up files may be read from disk and placed into memory in an expeditious manner, the system may not be immediately ready to use the files from memory. In fact, the system may be ready to use some of the files before, during, or after the files are being read from disk and placed into memory. When the system is ready to execute the instructions in a particular file, or ready to use the data in that file, a ‘demand request’ may be made for disk sector(s) that are known to contain the file. The flow diagram of FIG. 2 shows various ways the requested sectors might be retrieved, depending on where the data in those sectors is located at the time of the demand request.

In flow diagram 200, at 210 a demand request for one or more disk sectors may be received. In the descriptions contained herein, the term ‘sector’ may be interpreted to indicate either one sector or multiple sectors. In some embodiments, the demand request may be received from the operating system, although various embodiments of the invention are not limited in that respect. If the data in the sector is determined at 220 to already exist in memory (e.g., copied from the disk to main memory or a processor's cache memory), then the demand request may be satisfied from that memory at 230. If not, it may be determined at 240 whether the data in the sector is to be transferred from disk to memory, but the transfer has not yet been completed. This condition may describe a sector whose transfer has started but not yet completed, and/or a sector whose transfer has not yet started. In either case, the demand request for that sector may be deferred at 250 until the transfer is completed. In various embodiments or operations, ‘deferred’ may mean that the system will wait for the transfer to complete, and/or may mean that other demand requests will be processed until the deferred request can be satisfied.

If the answer at decision block 240 is no, then it may be assumed that the requested sector is either not in the contiguous locations, or is there but is inaccessible for some reason. In this case, it may be determined at 260 if the requested sector may be found in the non-contiguous locations. If so, the demand request may be deferred at 270 until the reading of the remaining start-up files from the contiguous locations has been completed (so as not to interrupt the desirable sequential reading of contiguous disk locations). Then the requested sector may be retrieved from the non-contiguous locations at 280 and placed in memory, from where the request may be satisfied. If the requested sector is neither in the contiguous locations nor the non-contiguous locations, some form of exception processing may be performed at 290.

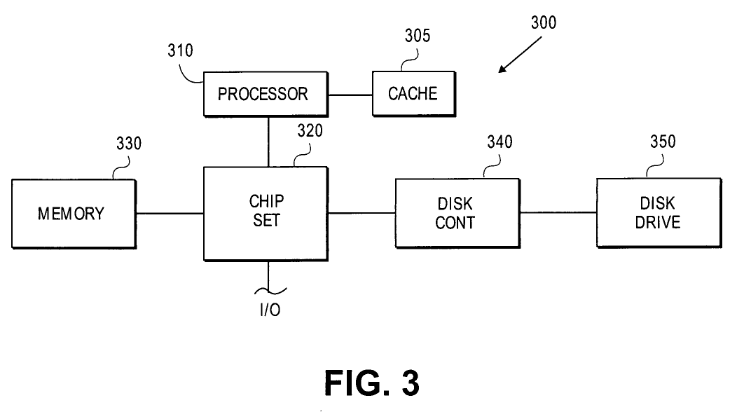

FIG. 3 shows a diagram of a computer system, according to an embodiment of the invention. In system 300, one or more processors 310 may be coupled to one or more main memory units 330, and coupled to one or more disk drives 350 through one or more disk controllers 340. The processor(s) may be coupled to one or more cache memories 305. The system may also contain other elements (not shown), such as but not limited to an input/output (I/O) interface to connect to other devices. In some embodiments a logic unit such as a chip set 320 may be used to couple various parts of the system together and to facilitate transfers between them. Although the parts of the system are shown coupled together in a specific manner, other system embodiments may have other parts, and/or may be coupled together differently.

In some embodiments, disk drive 350 may represent the disk previously described which contains contiguous and/or non-contiguous locations for start-up files. Main memory 330 and/or cache memory 305 may represent the memory previously described which may be used to contain the start-up files that have been read from disk.

The foregoing description is intended to be illustrative and not limiting. Variations will occur to those of skill in the art. Those variations are intended to be included in the various embodiments of the invention, which are limited only by the spirit and scope of the appended claims.

What is claimed is:

1. A system, comprising
a disk drive;
a memory; and
a processor coupled to the memory and to the disk drive;
wherein the system is adapted to:
write start-up files to substantially contiguous locations on the disk drive before entering a powerdown state;
enter the powerdown state;
determine an operational state is to be entered;
read the start-up files from the substantially contiguous locations; and
execute at least some of the start-up files.

2. The system of claim 1, wherein the powerdown state comprises a shutdown state.

3. The system of claim 2, wherein the start-up files comprise files to perform a boot operation.

4. The system of claim 1, wherein the powerdown state comprises a hibernate state.

5. The system of claim 4, wherein the start-up files comprise files to perform a resume operation.

6. The system of claim 1, wherein said reading the start-up files is not initiated by an operating system.

7. A method, comprising:
placing start-up files into substantially contiguous locations of a non-volatile storage medium;
entering a powerdown state;
determining an operational state is to be entered;
reading the start-up files from the substantially contiguous locations; and
writing the start-up files into memory.

8. The method of claim 7, wherein the powerdown state comprises a shutdown state.

9. The method of claim 7, wherein the powerdown state comprises a hibernate state.

10. The method of claim 7, wherein the storage medium is a disk drive, and said contiguous locations comprise sequentially addressable sectors.

11. The method of claim 7, wherein the storage medium is a disk drive, and the contiguous locations are selected from a list consisting of:
locations on a same track of the disk drive; and
locations on adjacent tracks of the disk drive.

12. The method of claim 7, further comprising determining, before said placing, that the powerdown state is to be entered.

13. The method of claim 7, further comprising:
requesting, subsequent to said determining, a particular start-up file for execution;
satisfying the request from the memory if the particular start-up file is currently available from the memory; and
deferring the request if the particular start-up file is not currently available from the memory and is located in the substantially contiguous locations.

14. The method of claim 13, further comprising reading the particular start-up file from non-contiguous locations of the non-volatile storage medium if the particular start-up file is not currently available from the memory and is not located in the substantially contiguous locations.

15. The method of claim 7, wherein said placing comprises copying said start-up files from non-contiguous locations of the non-volatile storage medium to the substantially contiguous locations of the non-volatile storage medium.

16. The method of claim 7, wherein said reading is not initiated by an operating system.

17. An article comprising
a machine-readable medium that provides instructions, which when executed by a computing platform, result in at least one machine performing operations comprising:
placing start-up files into substantially contiguous locations of a non-volatile storage medium;
entering a powerdown state;
determining an operational state is to be entered;
reading at least a portion of the start-up files from the substantially contiguous locations; and
writing the at least a portion of the start-up files into memory.

18. The article of claim 17, wherein the powerdown state comprises a state that requires accessing start-up files from a disk before the operational state may be entered.

19. The article of claim 17, wherein the storage medium is a disk drive.

20. The article of claim 17, further comprising determining, before said placing, that the powerdown state is to be entered.

21. The article of claim 17, further comprising:
requesting, subsequent to said determining, a particular start-up file for execution; and
satisfying the request from the memory if the particular start-up file is currently available from the memory, or deferring the request if the particular start-up file is not currently available from the memory and is located in the substantially contiguous locations.

22. The article of claim 21, further comprising reading the particular start-up file from non-contiguous locations of the non-volatile storage medium if the particular start-up file is not currently available from the memory and is not located in the substantially contiguous locations.

23. The article of claim 17, wherein said placing comprises copying said start-up files from non-contiguous locations of the non-volatile storage medium to the substantially contiguous locations of the non-volatile storage medium.

24. The article of claim 17, wherein said reading is not initiated by an operating system.
